(19) United States
(12) Patent Application Publication
(10) Pub. No.: US 2025/0178879 A1
(43) Pub. Date: Jun. 5, 2025

(54) TAPPING AND REGULATING DEVICE, AND CONTAINER HAVING SUCH A TAPPING AND REGULATING DEVICE

(71) Applicant: OAM GMBH, Wilhelmsfeld (DE)

(72) Inventor: Timm OBERHOFER, Wilhelmsfeld (DE)

(21) Appl. No.: 18/841,128

(22) PCT Filed: Feb. 23, 2022
(86) PCT No.: PCT/DE2022/200028

§ 371 Date: Aug. 23, 2024

(51) Int. Cl. B67D 1/04; B67D 1/08; B67D 1/12

(52) U.S. Cl. CPC B67D 1/0418; B67D 1/0801; B67D 1/1252

(57) ABSTRACT

The invention relates to a tapping and regulating device for dispensing a liquid from a container, in particular from a beverage container, preferably for dispensing a beer or a beer beverage from a keg, preferably from a 5-litre party keg, with a rod-shaped or cylinder-shaped arrangement composed of pressure unit, regulating unit and tapping unit, which arrangement can preferably be inserted almost flush into the container through an opening in the lid of the container, wherein the tapping unit can be transferred from a transport and storage position, in which it is inserted in the arrangement, to a use position, in which it is withdrawn from the arrangement and fluidically connected thereto, and wherein the withdrawn tapping unit is able to be mounted on the container, preferably at the latter's edge, fold or the like, for handling or actuating.

The invention relates to a tapping and regulating device for dispensing a liquid from a container, in particular from a beverage container, preferably for dispensing a beer or a beer beverage from a beer keg, preferably from a 5 L party beer keg. Furthermore, the invention relates to a container, for example a 5 L party beer keg, with a tapping and regulating device of this type.

Tapping and regulating devices of the generic type and beverage holders of the type discussed here are well known from practice. This applies, in particular, to what are known as 5 L party beer kegs.

A very wide variety of embodiments of party beer kegs are known. The beer kegs are frequently produced from tin plate and have a tap in the lower region, close to the bottom. An aerating and ventilating valve is provided in the upper region, preferably in the lid. This valve is opened when tapping, with the result that, on account of gravity, the beer can be discharged from the tap which is arranged in the lower region. It is disadvantageous here that, if there is a small residual quantity of beer, it is discharged merely hesitantly from the tap. Moreover, a residual quantity of beer remaining in the party beer keg spoils extremely quickly. Accordingly, the beer has to be consumed as quickly as possible.

EP 2 009 535 has disclosed a party beer keg, in the case of which the tap is arranged in the upper region of the beverage container, more precisely in the upper region of the side wall of the beverage container. In order to maintain a minimum pressure which is required for tapping purposes, a pressure source in the form of a carbon dioxide cartridge is arranged in the interior of the container. When beer is tapped, the pressure which prevails in the interior of the keg is automatically adjusted via the pressure source, with the result that this pressure is sufficient right up to the conclusion of the tapping operation for conveying the beer upward via the riser pipe to the tap.

DE 10 2019 207 114 A1 has likewise disclosed a 5 L party beer keg, wherein this beer keg also comprises a pressurized dispenser with carbon dioxide within the container. Here too, the tapping unit is arranged in the upper region of the wall of the beer keg, and has to be pulled out for tapping purposes orthogonally with respect to the longitudinal axis of the beer keg.

An activation device is installed in the bottom region for the activation of the pressure system, according to which the pressure system can be activated from outside the beer keg. A corresponding regulating valve is provided.

The known 5 L party beer kegs are problematic in practice, since the tap protrudes at least slightly outward with an actuating member in an unprotected manner even in the case of a tap which is pushed in, that is to say in the non-activated state, with the result that there is the risk, in particular during transport and during handling, that the outer region of the tap, in particular the actuating member which is also situated outside the container in the transport and storage position, is damaged. In such a case, the tapping unit becomes unusable. Moreover, the provision of separate units—pressure unit with a regulating unit and a tapping unit—is complicated in construction and when inserting into the container. The handling is complicated both for the beer filler and for the customer/end user.

The invention is therefore based on the object of configuring and developing a tapping and regulating device for dispensing a liquid from a container, in particular from a beverage container, preferably for dispensing a beer or a beer beverage from a beer keg, preferably from a 5 L party beer keg, in such a way that the handling is simple both for the filler of the beverage and for the end user. The risk of leaks in or on the container is intended to be avoided as far as possible. Furthermore, the tapping and regulating device is intended to be distinguished from competitive products.

The above object is achieved in relation to the tapping and regulating device according to the invention by way of the features of patent claim 1. In accordance with the latter, the tapping and regulating device comprises a rod-shaped or cylindrical arrangement, consisting of a pressure unit, a regulating unit and a tapping unit. In a departure from the prior art, the three units are combined with one another in a rod-shaped or cylindrical arrangement in a single-piece or multiple-piece housing. It is thus possible for the entire arrangement to be plugged through a single opening in the lid of the container in an approximately flush manner into the container, which opening is to be sealed. In contrast to the prior art, the container requires only a single opening, namely for introducing the entire arrangement. The necessary complexity for sealing purposes is reduced in comparison with the prior art.

The tapping unit can be moved from a transport and storage position, in which it is plugged into the arrangement, into a use position, in which it is removed from the arrangement and is flow-connected to the latter. This means that the tapping unit is first of all situated completely within the arrangement which is defined as a transport and storage position. A small region which serves to handle the tapping unit and to move the tapping unit into the use position is of flat configuration in such a way that it as far as possible comes into contact around the opening on the lid in a similar manner to a flat screw head. If it is assumed that this region lies at a substantially lower location than the surrounding edge or fold of the beer keg, that part of the tapping and regulating device which is arranged outside the container in the transport and storage position is protected peripherally, with the result that unintended damage is virtually ruled out.

If the tapping unit is removed out of its transport and storage position, for example by way of rotation of an outer part, it can be moved into a use position, namely by way of the tapping unit being pulled out of the rod-shaped or cylindrical arrangement which is situated within the container. It goes without saying that this arrangement is pressure-tight, with the result that no leak arises from the removal of the tapping unit. The flow connection of the tapping unit to the regulating unit makes a pressure-conveyed removal of the liquid or the beer possible where the tapping unit is positioned. This position is to be understood as the use position.

For simple and comfortable tapping, the tapping unit which is removed from the rod-shaped or cylindrical arrangement is fastened to the container, preferably at its edge or fold. The attachment can take place by way of plugging on or clipping on, in such a way that the actual tap protrudes beyond the side wall of the container, with the result that tapping can be carried out from the side as in the case of a conventional beer keg. It is to be ensured here that the flow connection out of the rod-shaped or cylindrical arrangement to the tapping unit is ensured. The above comments make it clear that the tapping and regulating device according to the invention makes simple handling up to tapping of the beer possible both for the filler and for the end user, wherein the arrangement of the tapping unit at the very top in the edge region of the container makes tapping even into relatively large glasses/containers possible.

In an advantageous way, the pressure unit comprises, as lower housing part, an end-side cartridge housing with a gas cartridge arranged therein. This is preferably a CO₂ cartridge. The cartridge housing is adjoined, as second housing part, by a sealing housing which seals with respect to the cartridge housing or is configured in one piece with the cartridge housing. Like the cartridge housing, the sealing housing is sealed to the outside at least in regions.

The sealing housing comprises a storage space which is not sealed to the outside and into which the tapping unit is plugged as far as possible, preferably upside down, in its transport and storage position. In the plugged-in state, the tapping unit closes off the sealing housing at the free end, wherein this is not a liquid-tight closure here. By way of rotation of the tapping unit, a rotary piston is rotated in the interior until an inlet hole in the sealing housing overlaps with an inlet hole in the rotary piston. As a result, the user activates the tapping device.

When the tapping unit is pulled out of its transport and storage position, the “empty” storage space which is sealed toward the interior, that is to say with respect to the regulating unit and pressure unit, remains, with the result that the pressurized liquid in the interior of the container cannot pass to the outside from there. The entire rod-shaped or cylindrical arrangement is sealed in the plugged-in state with respect to the edge of the opening, into which it is plugged into the container, to be precise in a pressure-tight manner, in accordance with the internal pressure which prevails in the container.

Between the two housing parts—cartridge housing and sealing housing, a middle housing part or a transition region can be provided in the two housing parts, in which the regulating unit is configured. The regulating unit is liquid-tight with respect to the storage space for the tapping unit, that is to say with respect to the surrounding area of the container.

The regulating unit can be arranged in a pressure sleeve which can be configured as an intermediate piece between the cartridge housing and the sealing housing.

A riser pipe for pressure-induced rising of the liquid is configured outside the cartridge housing and possibly the middle housing part or the transition region. The riser pipe can likewise be an integral constituent part of the housing parts. The riser pipe opens in the region of the sealing housing into the latter, to be precise opens in the interior of the sealing housing into an internal flow channel which is flow-connected via an elastic flow connection to the tapping channel of the tapping unit. Pressure therefore prevails exclusively in the flow connection and not in the storage space of the tapping unit. The latter is sealed with respect to the interior of the container.

The elastic flow connection is advantageously an elastic hose which is designed just so long that it firstly fits into the storage space and secondly leads as far as the use position of the tapping unit, namely in the pulled-out state of the tapping unit.

The pressure unit comprises a pressure sleeve with a screw-in sleeve and a valve tappet which can be actuated via the regulating unit which is operatively connected to it. The pressure cartridge is screwed into the screw-in sleeve and can be actuated via the valve tappet, wherein a first actuation takes place with removal of the tapping unit. The pressure cartridge is activated only afterward, and the gas which is required for dispensing the liquid can flow into the interior space of the container. When a predefined interior pressure is reached, the regulating unit closes the pressure unit automatically in a conventional way. Reference is to be made in this regard to the prior art cited at the outset.

The regulating unit comprises a membrane which acts on the valve tappet and is subjected to the pressure of a pressure chamber which is configured between the pressure sleeve and the membrane. The pressure cartridge opens or closes in a conventional way via the valve tappet counter to the pressure of a pressure compressor which is loaded with spring force.

An overpressure protection means, which, in addition to a seal ring, can comprise a rupture disk loaded with spring force, is provided between the regulating unit and the tapping unit, preferably in a region of the pressure housing which faces the regulating unit. The seal ring is an indicator for one-time triggering.

The tapping unit comprises a tap head, with a tapping channel which adjoins the elastic hose, and a tap handle which serves for actuation purposes. It is to be noted at this point that the flow connection of the elastic hose can be realized on both sides by way of the hose being plugged on by means of a clamping action.

Furthermore, it is advantageous if the tapping unit comprises a type of valve barrel which gradually opens or closes the tapping channel upon actuation of the tap handle. The flow channel can thus be opened or closed from the completely closed state up to the completely open state and vice versa. Metering or throttling of the liquid quantity to be dispensed is possible.

At its front-side end, the tapping unit comprises a handling member which serves to pull the tapping unit out of the pressure-free storage space within the rod-shaped or cylindrical arrangement. As a result, the tapping unit passes out of the secured transport position into the actuating position, wherein the tapping unit is moved manually to this position.

It is advantageous, furthermore, if the arrangement comprises a tamper-proof seal. In the transport position, the tamper-proof seal connects the tap head to the sealing housing in a releasable way. At the same time, the tamper-proof seal can close the free end of the tapping channel, that is to say the outlet. When the tapping unit is pulled out by means of the handling member, the tamper-proof seal is detached from the sealing housing irreversibly. It can break in the process, for example.

Afterward, it releases the tapping channel to the outlet. It is to be noted at this point that, as a result of removal of the tapping unit, the regulating unit acts on the pressure unit, and tapping is possible on account of an outflow of the gas upon actuation of the tap handle.

In order to position the tap head, the latter has a clamping device, in the simplest case a gap which is suitable for plugging onto the fold and serves to plug the tap head in a clamping manner onto the edge or fold of the container. For reliable attachment, the clamping device can be equipped with an undercut, with the result that the tap head can be latched at or on the fold. Secure positioning of the tap head can be ensured as a result.

At its free end, the sealing housing can have a flange or a peripheral shoulder for external contact with the edge of the opening in the lid of the container. In this way, reliable positioning of the rod-shaped or cylindrical arrangement is ensured. Moreover, the sealing housing can have a latching means with sealing means for sealing with respect to the opening in the lid of the container below or behind the flange or the shoulder, with the result that, after the rod-shaped or cylindrical arrangement is inserted into the beer keg by the filler, a liquid-tight and pressure-tight arrangement is created, in an advantageous way with respect to the prior art with a single opening in the container.

The container according to the invention, which can be any desired beverage container, in particular a beer keg, further particularly a 5 L party beer keg, comprises the above-explained tapping and regulating device for dispensing the liquid. Therefore, this container is inventive in comparison with conventional containers of the type discussed here.

There are now various possibilities to configure and develop the teaching of the present invention in an advantageous way. To this end, reference is to be made firstly to the further independent claims to claim 1 and secondly to the following explanation of one preferred exemplary embodiment of the invention on the basis of the drawing. In conjunction with the explanation of the preferred exemplary embodiment of the invention on the basis of the drawing, preferred refinements and developments of the teaching will also be explained generally. In the drawing:

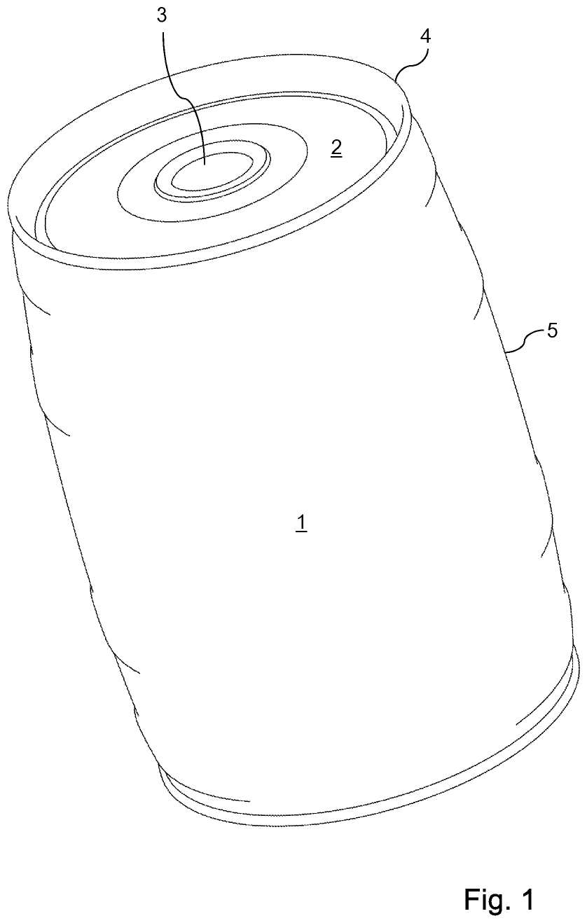

FIG. 1 shows a diagrammatic view of one exemplary embodiment of a 5 L party beer keg according to the invention with an opening in the lid, without a tapping and regulating device,

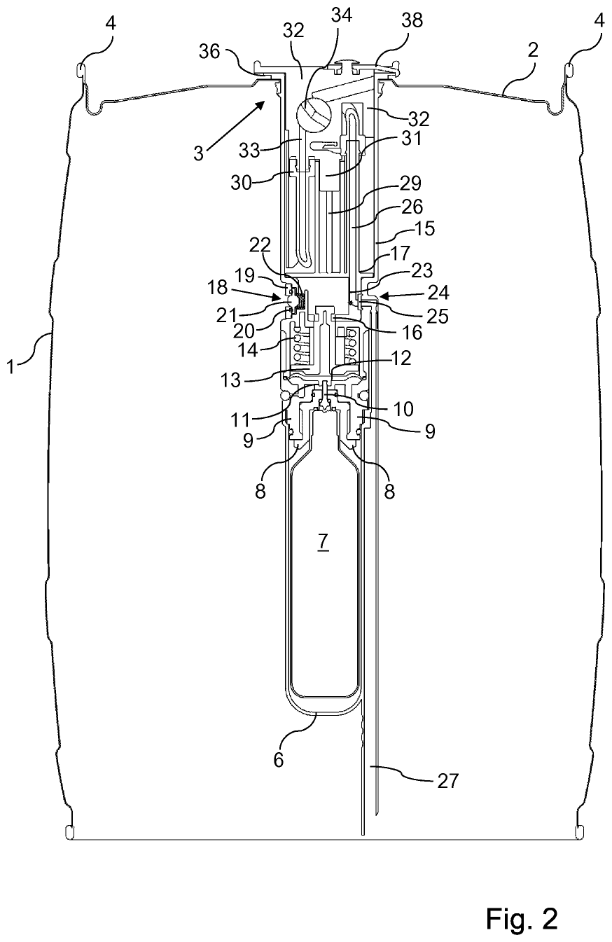

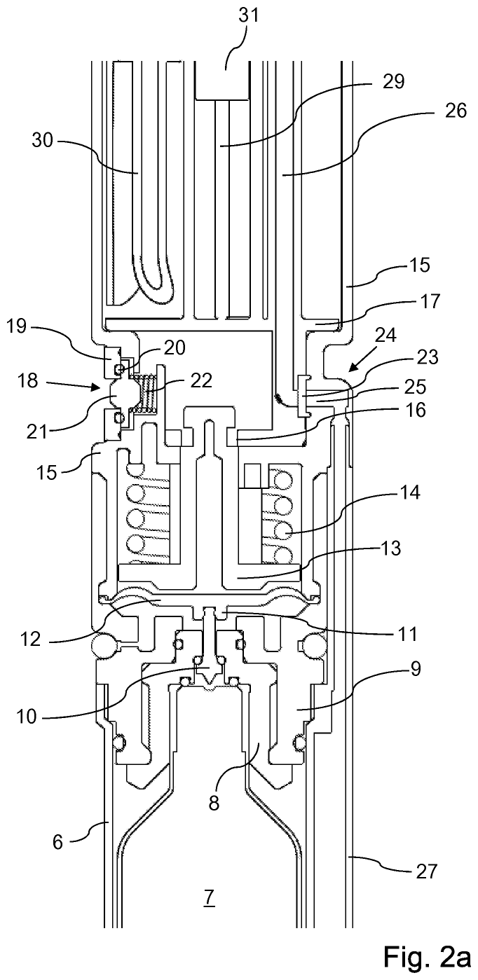

FIG. 2 shows a diagrammatic view, in section, of a 5 L party beer keg with an inserted tapping and regulating device according to the invention, wherein the tapping unit is situated in the transport and storage position within a rod-shaped or cylindrical arrangement,

FIG. 2a shows a diagrammatic view, in part and on an enlarged scale, of the pressure and regulating device of the object from FIG. 2,

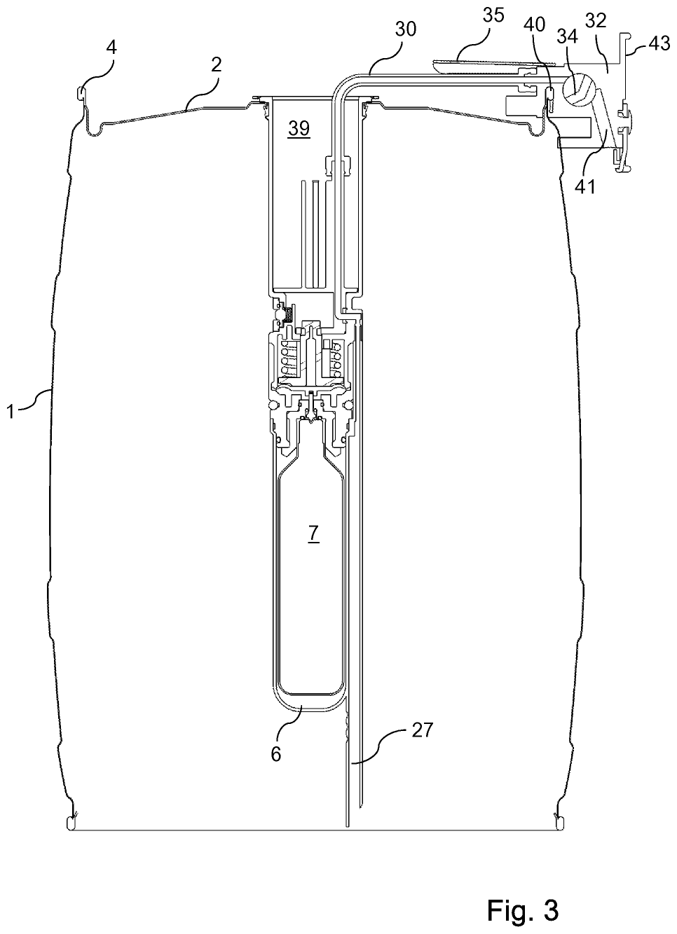

FIG. 3 shows a diagrammatic view of the object from FIG. 2, wherein the tapping unit is pulled out of the rod-shaped or cylindrical arrangement and is situated in the use position, in which it is clipped onto the fold of the beer keg,

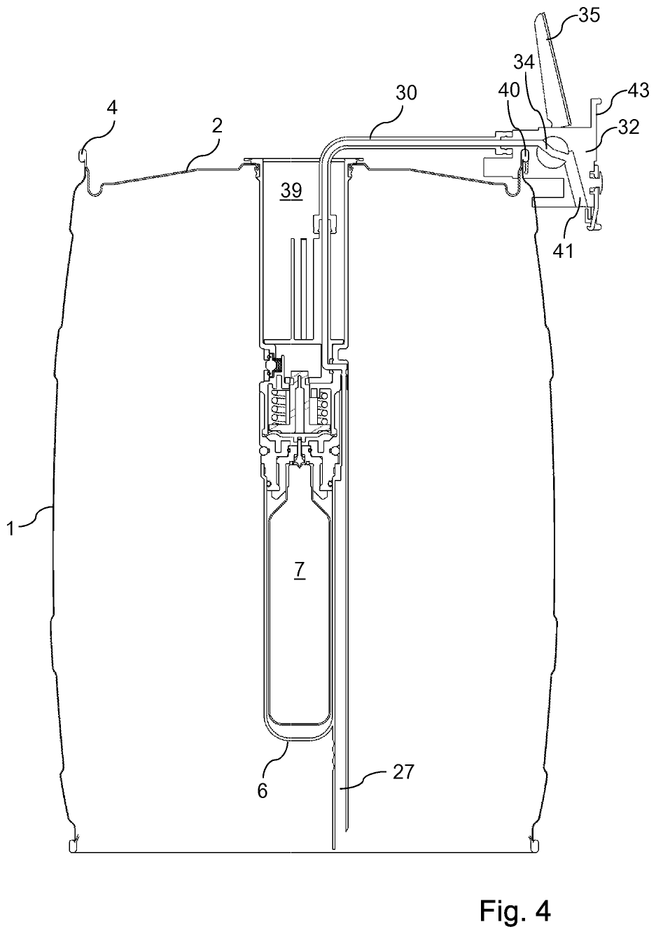

FIG. 4 shows a diagrammatic view of the object from FIG. 3, wherein the tap handle which serves for tapping purposes is raised,

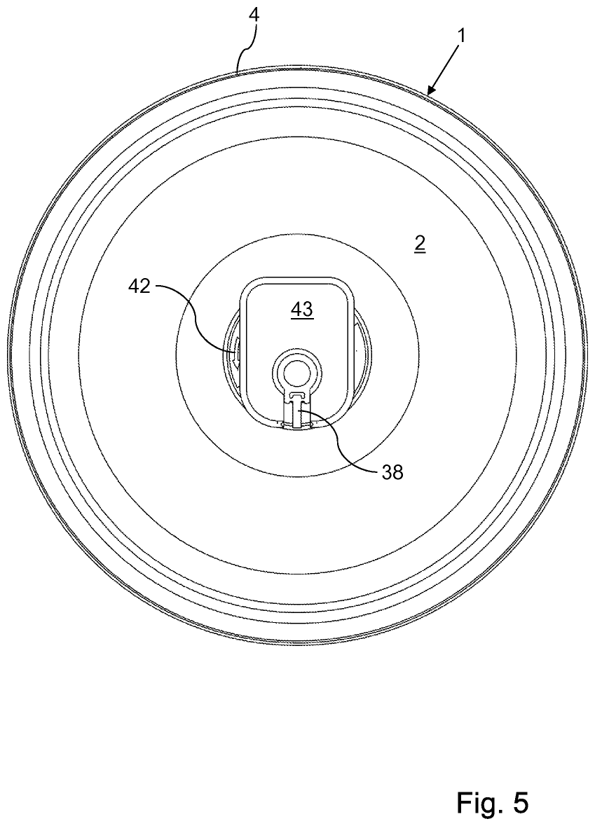

FIG. 5 shows the beer keg in accordance with the illustration from FIG. 2 in a plan view,

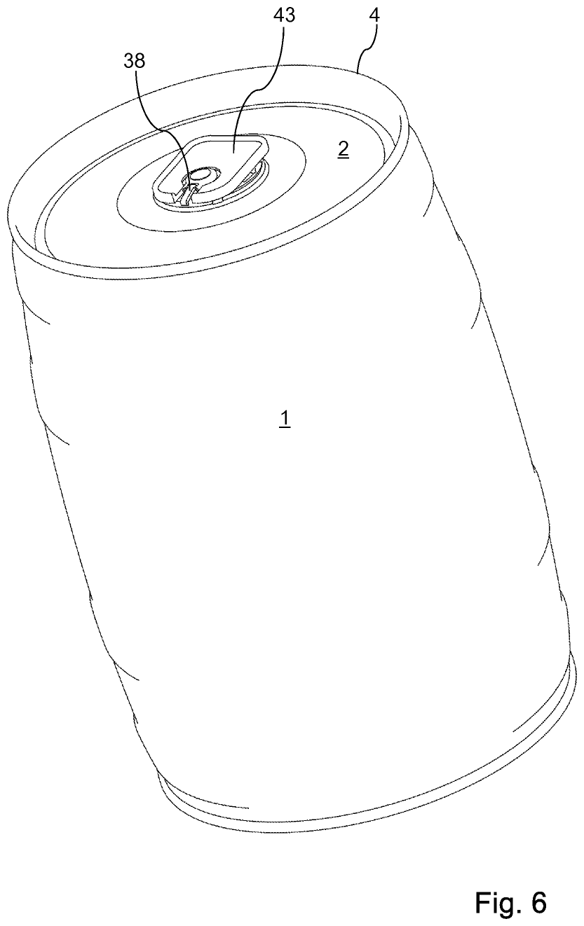

FIG. 6 shows the beer keg in accordance with the illustration from FIG. 2 in a perspective view,

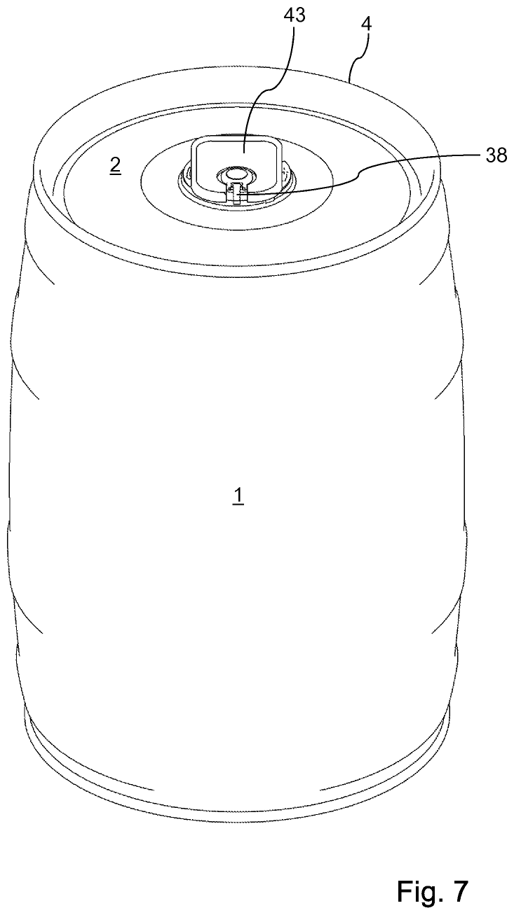

FIG. 7 shows the beer keg in accordance with the illustration from FIG. 2 in a frontal view, and

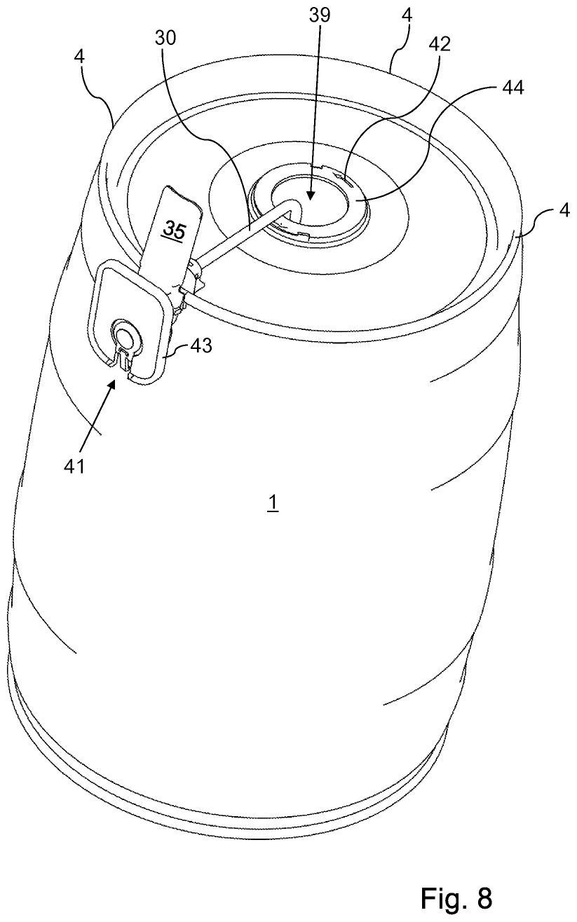

FIG. 8 shows the beer keg in accordance with the illustration from FIG. 4 in a perspective view.

FIG. 1 shows a diagrammatic view of a 5 L beer keg 1. An opening 3 which is to be understood to be the only opening in the beer keg 1 is configured at the top in the lid 2. As a consequence, only a single opening 3 is also to be sealed in the case of this beer keg 1.

FIG. 1 shows, furthermore, that the lid 2 is connected via a fold 4 to the wall 5.

FIG. 2 shows a diagrammatic sectional illustration of the beer keg 1 according to FIG. 1, wherein the tapping and regulating device according to the invention is plugged in an approximately flush manner into the opening 3. From bottom to top, the tapping and regulating device can be described as follows:

A CO₂ cartridge 7 is arranged in a cartridge housing 6. The cartridge 7 is screwed into a screw-in sleeve 8 which consists of plastic or stainless steel. The screw-in sleeve 8 is in turn situated in a pressure sleeve 9, wherein the screw-in sleeve 8 can be screwed into or fastened in some other way to the pressure sleeve 9.

A valve tappet 10 which dips with the end of its shank into a flange base 11 of a membrane 12 is situated above the pressure sleeve 9. The membrane 12 serves to actuate the valve tappet 10.

A spring compressor 13 is arranged above the membrane 12, wherein a regulating spring 14 comes into contact on the spring compressor 13. The spring compressor 13 and the regulating spring 14 are surrounded by the sealing housing 15 which is screwed into the pressure sleeve 9.

The upper shank end of the spring compressor 13 protrudes through a through opening 16 in the sealing housing 15 as far as a passage at the lower end of the rotary piston 17, in which the spring compressor 13 is latched. The regulating spring 14 or the plate of the spring compressor 13 is not in contact with the membrane 12. The regulating spring 14 is compressed.

An overpressure protection means 18 is provided in the clearance between the upper shank end of the spring compressor 13 and the lower end of the rotary piston 17. The overpressure protection means 18 comprises a sealing disk 19 with a rupture disk 21 which is sealed by way of an O-ring 20. This sealing disk is pressed outward against the rupture disk 21 by way of a compression spring 22 which is supported on the inside on the sealing housing 15.

A sealing surface 23 which is attached to the rotary piston 17 and seals against a through arch 24 in the sealing housing 15 lies opposite the overpressure protection means 18. An inlet hole 25 is provided on the sealing housing 15 for the flow channel of the rotary piston 17 on the opposite side, along the sealing surface 23.

The upper end, running or attached to the cartridge housing 6, of a riser pipe 27 moves in a positively locking manner into the housing 1 at the outer lower end of the through arch 24 of the sealing housing 15.

The flow channel 26 and an activating web 29 of the rotary piston 17 protrude into the upper, inner clearance 28 of the sealing housing 15.

A hose 30, which is fastened to the flow channel 26 of the rotary piston 17, and an activating pin 31, pushed into the activating web 29, of the tap head 32 adjoin one another. An inlet channel 33, to which the other free end of the hose 30 is fastened, is situated opposite the activating pin 31.

The inlet channel 33 of the tap head 32 opens into a valve barrel 34, to which a tap handle 35 is fastened.

A seal 36 which acts with respect to the outer wall of the keg lid 2 in the region of the opening 3 is provided on the flange of the sealing housing 15. Moreover, a tamper-proof seal 38 which is connected to the tap head 32 is provided.

FIG. 2a shows the essential details explained with respect to FIG. 2 in an enlarged illustration.

FIG. 3 differs from FIG. 1 in that the tapping unit is moved out of its transport and storage position into the removed use position. Specifically, the tap head 32 is plugged onto the fold 4 of the keg lid 2. It can be seen clearly that the hose 30 flow-connects the tap head 32 to the riser pipe 27 via the rotary piston 17. The storage space 39 which is open to the outside is now empty and open to the outside. It is sealed with respect to the keg interior.

Furthermore, FIG. 3 shows that the actuating member which serves for tapping purposes, namely the tap handle 35, is situated in a laid-flat position.

According to FIG. 4, the tap handle 35 is deployed and can be actuated, as a result of which the valve barrel 34 is rotated.

FIGS. 2 to 4 show, furthermore, that the tap head 32 comprises a slot-like clamping device 40, by way of which the tap head 32 is plugged in a clamping manner onto the fold 4.

The figures show, furthermore, the downwardly directed outlet 41 which is configured in the tap head 32.

FIG. 5 shows the beer keg, equipped with the tapping and regulating device according to the invention, from above, wherein the tapping unit is situated in the transport and storage position. An arrow 42 indicates the rotational direction, in which the bracket or plate 43 which can be seen from above is to be rotated, in order that the tap head 32 which is situated in the storage space 39 under an at least small stress passes out of the storage space 39.

FIG. 6 shows the keg equipped with the tapping and regulating device according to the invention in a diagrammatic, perspective side view, and FIG. 7 shows the object from FIG. 6 in a front view.

In accordance with the illustration in FIG. 8, the tapping unit is situated in the use position, and the tap head 32 is plugged onto the upper outer edge, that is to say onto the fold 4 of the beer keg 1. The tap handle 35 is deployed for tapping. The hose 30 leads out of the keg interior, through the opening 3 to the tap head 32. It can be seen, furthermore, that a fastening collar or flange 44 is provided on the opening 3 or at the upper end of the storage space 39, on which fastening collar or flange the tap head can be fixed in a screw-like or bayonet-like manner in the plugged-in state within the storage space 39.

The following is to be stated in key words with respect to the function of the above-explained tapping and regulating device:
The valve tappet pierces the CO₂ cartridge with its tip. This either already takes place during assembly by the filler or, in the case of a corresponding configuration of the sealing housing and the rotary piston and the spring compressor, by way of the consumer. As soon as the CO₂ cartridge is activated, the pressure which serves to convey the liquid prevails at the bottom of the valve tappet.
The end user rotates the tap head, situated in the transport position, in accordance with a functional instruction by between 10 to 120° in or counter to the clockwise direction, depending on the embodiment.
The tap head is connected by way of its activating pin in the activating web to the rotary piston and correspondingly also rotates the latter.
On account of the rotational movement of the rotary piston, the inlet hole on the sealing surface of the rotary piston is brought into an overlap with the outlet hole of the through arch of the sealing housing. The fluid channel (riser pipe, flow channel, hose) is released in this way.
Upper cutouts on the flange of the sealing housing release the tap head which can be removed upward out of the sealing housing out of its transport position.
A valve barrel is configured in the tap head, on which valve barrel a tap handle engages or acts. Moreover, the free end of the hose is fastened to the tap head. The tap head is pulled together with the hose out of the sealing housing or out of the storage space of the sealing housing. The tap head is then pressed by a clamping device, more precisely on its notch, with a certain pressure upward onto the fold of the keg, and can latch there below the fold by means of a latching lug.
Afterward, the tap handle is moved upward. As a result, it rotates the valve barrel. The latter releases the flow path of the fluid channel and the tapping channel. The fluid can exit through the outlet.
The pressure in the interior of the container drops during tapping. As soon as the pressure drops below a predefined level, the regulating spring presses the membrane downward in the direction of the valve tappet. As a result, CO₂ escapes from the CO₂ cartridge in the direction of the pressure chamber and passes via the outflow channel below the O-ring in the direction of the container. The pressure in the container rises again. Pressure equalization arises between the pressure chamber and the container. The two regions are at the same pressure. Atmospheric pressure prevails above the membrane. This atmospheric pressure arises as a result of the free access to the atmosphere via the through opening between the spring compressor, the rotary piston and the sealing housing.
The regulating pressure in the pressure chamber is determined by way of the specific embodiment of the regulating spring which is pressed upward onto the membrane via the active surface in the pressure chamber in the case of a prevailing pressure. The valve tappet is then no longer pressed downward actively out of the regulating spring or the membrane. CO₂ can no longer flow out from the CO₂ cartridge in the direction of the pressure chamber.
The pressure equalization is prevented until pressure again escapes from the container as a result of the tapping operation. The above-explained regulating operation begins again and is repeated as desired as long as liquid is situated in the container or as long as the CO₂ cartridge provides pressure medium.
Should a malfunction occur during regulating of the pressure, for example if CO₂ escapes into the container in an uncontrolled and excessively rapid manner, or should the container pass into a critical pressure state as high as the bursting range on account of great heating, the CO₂ can escape in a controlled manner without bursting the container with the aid of the installed overpressure protection means.

The overpressure protection means operates as follows:
A sealing disk with a hole in the middle is provided. It is separated from the rupture disk and sealed by way of an O-ring. A spring which presses against the rupture disk is arranged behind the rupture disk. If the pressure in the interior of the container rises above a predefined value, the rupture disk lifts from the O-ring as a result of the prevailing pressure in the hole of the sealing disk. The spring which lies behind it is compressed. Correspondingly, the hole in the sealing disk is released, and pressure can escape outward to the atmosphere via the sealing housing past the rupture disk.

The above comments in respect of the function of the tapping and regulating device according to the invention do not restrict it via the specific features of the patent claims. They serve rather for explanatory purposes.

Reference is made to the general part of the description and to the appended claims with regard to further advantageous refinements of the apparatus according to the invention, in order to avoid repetitions.

Finally, it is to be noted expressly that the above-described exemplary embodiment of the teaching according to the invention serves merely to explain the claimed teaching, but does not restrict it to the exemplary embodiment.
Container, keg, beer keg
Lid, keg lid
3 Opening (at the top in the container)
4 Fold
5 Wall (of the container)
6 Cartridge housing
7 Cartridge, pressure cartridge
8 Screw-in sleeve
9 Pressure sleeve
10 Valve tappet
11 Flange base
12 Membrane
13 Spring compressor
14 Regulating spring
15 Sealing housing
16 Through opening
17 Rotary piston
18 Overpressure protection means
19 Sealing disk
20 O-ring
21 Rupture disk, rupture ring
22 Compression spring
23 Sealing surface
24 Through arch
25 Inlet hole, inlet opening
26 Flow channel
27 Riser pipe
28 Clearance
29 Activating web
33 Inlet channel
34 Valve barrel
35 Tap handle
36 Seal
37 Not allocated
38 Tamper-proof seal
39 Storage space (in the sealing housing)
40 Clamping device
41 Outlet

1. A tapping and regulating device for dispensing a liquid from a container, in particular from a beverage container, preferably for dispensing a beer or a beer beverage from a beer keg, preferably from a 5 L party beer keg, with a rod-shaped or cylindrical arrangement, consisting of a pressure unit, a regulating unit and a tapping unit, which can preferably be plugged through an opening in the lid of the container in an approximately flush manner into the container, wherein the tapping unit can be moved from a transport and storage position, in which it is plugged into the arrangement, into a use position, in which it is removed from the arrangement and is flow-connected to the latter, and wherein the removed tapping unit can be attached to the container, preferably to its edge, fold or the like for handling or actuating.

2. The tapping and regulating device as claimed in claim 1, characterized in that the pressure unit comprises, as lower housing part, an end-side cartridge housing with a gas cartridge arranged therein, preferably a CO₂ cartridge, which end-side cartridge housing is adjoined, as second housing part, by a sealing housing, in which the tapping unit is arranged as far as possible in its transport and storage position and closes off the sealing housing at the free end.

3. The tapping and regulating device as claimed in claim 2, characterized in that a middle housing part is configured between the two housing parts, or a transition region is configured in the two housing parts by way of the regulating unit.

4. The tapping and regulating device as claimed in claim 3, characterized in that, possibly as an integral constituent part of the housing parts, a riser pipe for pressure-induced rising of the liquid is configured outside the cartridge housing and possibly the middle housing part or the transition region, which riser pipe opens in the region of the sealing housing into the latter and opens in the interior of the sealing housing into an internal flow channel which is flow-connected via an elastic flow connection to a tapping channel of the tapping unit.

5. The tapping and regulating device as claimed in claim 4, characterized in that the elastic flow connection is configured as an elastic hose which is just so long that the tapping unit can be moved into its use position.

6. The tapping and regulating device as claimed in claim 1, characterized in that the pressure unit comprises a pressure sleeve with a screw-in sleeve with a valve tappet which can be actuated via the regulating unit which is operatively connected to it, wherein the pressure cartridge is screwed into the screw-in sleeve and can be actuated via the valve tappet.

7. The tapping and regulating device as claimed in claim 6, characterized in that the regulating unit comprises a membrane which acts on the valve tappet and is subjected to the pressure of a pressure chamber which is configured between the pressure sleeve and the membrane, and opens or closes the pressure cartridge via the valve tappet counter to the pressure of a pressure compressor which is loaded with spring force.

8. The tapping and regulating device as claimed in claim 2, characterized in that an overpressure protection means, which, in addition to a seal ring, can comprise a rupture disk loaded with spring force, is provided between the regulating unit and the tapping unit, preferably in a region of the sealing housing which faces the regulating unit.

9. The tapping and regulating device as claimed in claim 5, characterized in that the tapping unit comprises a tap head, with a tapping channel which adjoins the elastic hose, and a tap handle which serves for actuation purposes.

10. The tapping and regulating device as claimed in claim 9, characterized in that the tapping unit comprises a valve barrel which gradually opens or closes the tapping channel upon actuation of the tap handle.

11. The tapping and regulating device as claimed in claim 9, characterized in that, at its front-side end, the tapping unit comprises a handling member for pulling the tapping unit out of the transport position into the actuating position.

12. The tapping and regulating device as claimed in claim 11, characterized in that, in the transport position, a tamper-proof seal connects the tap head releasably to the sealing housing and possibly closes the free end of the tapping channel which, when the tapping unit is pulled out of the sealing housing by means of the handling member, detaches or breaks irreversibly and possibly opens the tapping channel for the free outlet.

13. The tapping and regulating device as claimed in claim 9, characterized in that a clamping device which serves to plug the tap head in a clamping manner onto the edge or fold of the container is provided in the tap head.

14. The tapping and regulating device as claimed in claim 2, characterized in that, at its free end, the sealing housing has a flange or a peripheral shoulder for external contact with the edge of the opening in the lid of the container.

15. The tapping and regulating device as claimed in claim 14, characterized in that, below or behind the flange or the shoulder, the sealing housing has a latching means with sealing means for sealing with respect to the opening in the lid of the container.

16. A container, in particular a beverage container, preferably a beer keg for beer or for a beer beverage, for example a 5 L party beer keg, with a tapping and regulating device for dispensing a liquid as claimed in claim 1.
